(19) United States
(12) Patent Application Publication
(10) Pub. No.: US 2024/0320628 A1
(43) Pub. Date: Sep. 26, 2024

(54) METHOD, APPARATUS, DEVICE, AND COMPUTER-READABLE STORAGE MEDIUM FOR VISUALIZING PERSONAL RESUME

(71) Applicant: Beijing Hydrophis Network Technology Co., Ltd., Beijing (CN)

(72) Inventors: Feng Hong, Beijing (CN); Min Huang, Beijing (CN); Weijie Zhou, Beijing (CN); Shanliang Xiong, Beijing (CN); Wenbi Cai, Beijing (CN); Youpeng Wei, Beijing (CN)

(21) Appl. No.: 18/600,590

(22) Filed: Mar. 8, 2024

(30) Foreign Application Priority Data
Mar. 24, 2023 (CN) 202310300634.8

(51) Int. Cl. G06Q 10/105; G06F 40/295; G06V 40/16

(52) U.S. Cl. CPC G06Q 10/105; G06F 40/295; G06V 40/16

(57) ABSTRACT

The present invention relates to data processing technology and discloses a method for visualizing a personal resume, including: acquiring a personal resume information set, constructing an individual resume visualization graph based on an entity relationship of personal resume experience in the personal resume information set, performing person portrait modeling on different persons in the personal resume information set based on the individual resume visualization graph to obtain person portrait data, performing entity clustering on different persons in the personal resume information set based on the person portrait data, constructing an entity distribution visualization graph according to a clustering result, and constructing a person relationship visualization graph based on an entity relationship between different persons in the personal resume information set. The present invention also provides an apparatus, a device, and a computer-readable storage medium for visualizing a personal resume. The present invention may realize the visualization of personal resume information.

### CROSS REFERENCE TO RELATED APPLICATIONS

The present application claims the benefit of Chinese Patent Application No. 202310300634.8 filed on Mar. 24, 2023, the contents of which are incorporated herein by reference in their entirety.

### TECHNICAL FIELD

The present invention relates to the technical field of data processing, and more particularly, to a method, an apparatus, an electronic device, and a computer-readable storage medium for visualizing a personal resume.

### BACKGROUND

With the rise of artificial intelligence, each item of data in the age of datamation shows the growth of exponential scale, for example, by using electronic archives, and electronic resumes to describe people's resumes, the visualization of data becomes more and more important.

With the popularity of electronic resumes, people's resumes contain more and more information, it is difficult to quickly find the key information from a large number of people's resumes information, and the deep mining of people is becoming more and more important. In the prior art, the degree of visualization of resume data based only on forms such as PDF and Word is low, and it is difficult to intuitively display people and relationships between people.

### SUMMARY

The present invention provides a method, an apparatus, an electronic device, and a readable storage medium for visualizing a personal resume, the main object of which is to realize the visualization of the personal resume information.

In order to realize the above object, the present invention provides a method for visualizing a personal resume, including:
acquiring a personal resume information set, constructing an individual resume visualization graph based on an entity relationship of personal resume experience in the personal resume information set;
performing person portrait modeling on different persons in the personal resume information set based on the individual resume visualization graph to obtain a person portrait data;
performing entity clustering on different persons in the personal resume information set based on the person portrait data, constructing an entity distribution visualization graph according to the clustering result;
constructing a person relationship visualization graph based on the entity relationship between different persons in the personal resume information set.

Optionally, the constructing an individual resume visualization graph based on an entity relationship of personal resume experience in the personal resume information set includes:
extracting a resume text of a target person in the personal resume information set;
using a pre-constructed entity relationship recognition model to recognize a basic information entity, a basic information relationship, a resume experience entity, and a resume experience relationship corresponding to each target person in the resume text;
constructing an individual resume visualization graph of the target person based on the basic information entity, the basic information relationship, the resume experience entity, and the resume experience relationship.

Optionally, the constructing an individual resume visualization graph of the target person based on the basic information entity, the basic information relationship, the resume experience entity, and the resume experience relationship includes:
taking the target person as a root node, constructing an undirected edge between the root node and the basic information entity based on the basic information relationship, and using the basic information relationship to label the undirected edge;
constructing a directed edge between the root node and the resume experience entity based on a time sequence of the resume experience relationship, and using the resume experience relationship to label the directed edge;
aggregating all the nodes and labeled links to obtain an individual resume visualization graph.

Optionally, the performing person portrait modeling on different persons in the personal resume information set based on the individual resume visualization graph to obtain a person portrait data includes:
constructing a person ID of a target person in the individual resume visualization graph, outputting an entity of each node in the individual resume visualization graph as an entity tag, and outputting a relationship between each node as an entity attribute corresponding to the entity tag;
mapping the entity tag and the entity attribute with the person ID to obtain the person portrait data of the target person.

Optionally, the performing entity clustering on different persons in the personal resume information set based on the person portrait data, constructing an entity distribution visualization graph according to the clustering result includes:
determining a target attribute from the entity attribute, and performing entity division on an entity tag corresponding to the target attribute according to the target attribute and a pre-set division range;
counting persons corresponding to an entity tag in each division range, and writing a target attribute in each division range and an entity tag corresponding to the target attribute in each division range as parameters into a pre-constructed graphic visualization template to obtain a classification visualization script;
converting the classification visualization script into a visualization file in a pre-set format, and performing asynchronous loading on the visualization file to obtain a distribution visualization graph.

Optionally, the constructing a person relationship visualization graph based on the entity relationship between different persons in the personal resume information set includes:
recognizing a department and a post of different persons in the personal resume information set;
using a pre-constructed face recognition model to recognize person images of different persons in the personal resume information set, aggregating target persons of the same department in the personal resume information set, taking different target persons as nodes, filling the person images into corresponding nodes, and constructing an organizational relationship between different nodes based on the post, to obtain an original relationship graph;
connecting the original relationship graphs of different departments based on a pre-set organizational structure to obtain the person relationship visualization graph.

Optionally, the using a pre-constructed face recognition model to recognize person images of different persons in the personal resume information set includes:
using a pre-constructed face recognition model to recognize face images of different persons in the personal resume information set;
performing face alignment on the recognized face image and cutting same to obtain person images of different persons in the personal resume information set.

In order to solve the above problems, the present invention also provides an apparatus for visualizing a personal resume, including:
an individual resume visualization graph construction module for acquiring a personal resume information set, constructing an individual resume visualization graph based on an entity relationship of personal resume experience in the personal resume information set;
a portrait data construction module for performing person portrait modeling on different persons in the personal resume information set based on the individual resume visualization graph to obtain a person portrait data;
an entity distribution visualization graph construction module for performing entity clustering on different persons in the personal resume information set based on the person portrait data, constructing an entity distribution visualization graph according to the clustering result;
a person relationship visualization graph construction module for constructing a person relationship visualization graph based on the entity relationship between different persons in the personal resume information set.

In order to solve the above problems, the present invention also provides an electronic device including:
a memory storing at least one computer program; and
a processor executing a computer program stored in the memory to realize the above-mentioned method for visualizing a personal resume.

In order to solve the above-described problems, the present invention also provides a computer-readable storage medium having stored therein at least one computer program that is executed by a processor in an electronic device to realize the above-described method for visualizing a personal resume.

In the present embodiment, an individual resume visualization graph is constructed through an entity relationship of personal resume experience in a personal resume information set; person portrait modeling is performed on different persons in the personal resume information set based on the visualization graph of an individual resume to obtain person portrait data; the personal resume data can be structured to improve data processing speed; entity clustering is performed on different persons in the personal resume information set based on the person portrait data; an entity distribution visualization graph is constructed according to the clustering result; and finally, a person relationship visualization graph is constructed based on entity relationships between different persons in the personal resume information set. It fully demonstrates the relationship between the persons and improves the visualization of the individual resume data. Therefore, the method, the apparatus, the electronic device, and the computer-readable storage medium for visualizing a personal resume provided by the present invention can realize the visualization of personal resume information.

### BRIEF DESCRIPTION OF THE ACCOMPANYING DRAWINGS

FIG. 1 is a flow diagram of a method for visualizing a personal resume according to an embodiment of the present invention;

FIG. 2 is a functional module diagram of an apparatus for visualizing a personal resume according to an embodiment of the present invention;

FIG. 3 is a structure diagram of an electronic device for realizing the method for visualizing a personal resume according to an embodiment of the present invention.

The realization of the objects, functional features, and advantages of the present invention will be further described with reference to the accompanying drawings in conjunction with the embodiments.

### DETAILED DESCRIPTION OF ILLUSTRATED EMBODIMENTS

It should be understood that the particular embodiments described herein are illustrative only and are not limiting.

Embodiments of the present application provide a method for visualizing a personal resume. The execution subject of the method for visualizing a personal resume includes but is not limited to, at least one of the electronic devices including a service end, a terminal, and the like that can be configured to execute the method provided by the embodiments of the present application. In other words, the method for visualizing a personal resume may be executed by software or hardware installed on a terminal device or a service end device, which may be a blockchain platform. The service end includes but is not limited to a single server, a server cluster, a cloud server, or a cloud server cluster, etc. The server can be an independent server, and can also be a cloud server providing basic cloud computing services, such as a cloud service, a cloud database, cloud computing, a cloud function, cloud storage, a network service, cloud communication, a middleware service, a domain name service, a security service, a content delivery network (CDN), and a large data and artificial intelligence platform.

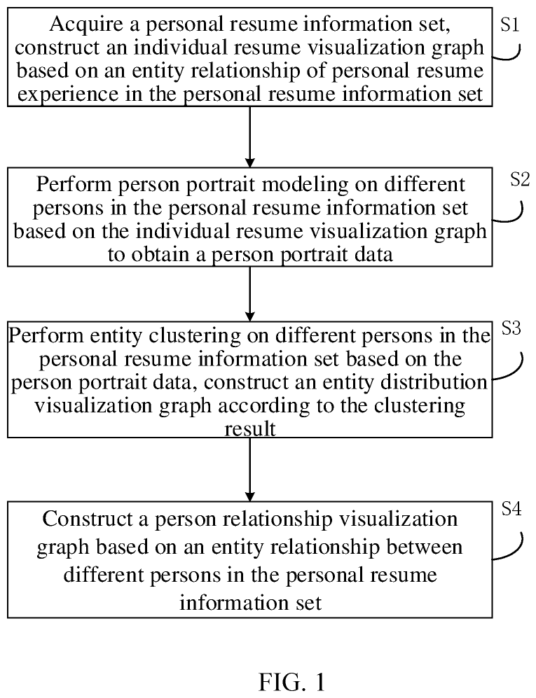

With reference to FIG. 1, a flow diagram of a method for visualizing a personal resume is shown. In the present embodiment, the method for visualizing a personal resume includes:

S1, acquiring a personal resume information set, constructing an individual resume visualization graph based on an entity relationship of personal resume experience in the personal resume information set.

In an embodiment of the present invention, the personal resume information set refers to past information sets of persons in enterprises and institutions in different fields, including: individual resumes, personal profiles, and individual resume experience data crawled from the Internet. The individual resume visualization graph refers to a visualization knowledge map that connects the experiences of persons in different local entities in series according to time dimension relationships, attribute dimension relationships, etc. For example, a person

$$A {\to }^{2000 ‐ 2015} department B ,$$

wherein person A represents a person entity, department B represents a department entity, and 2000-2015 represents a time relationship.

In detail, the constructing an individual resume visualization graph based on an entity relationship of personal resume experience in the personal resume information set includes: extracting a resume text of a target person in the personal resume information set;
using a pre-constructed entity relationship recognition model to recognize a basic information entity, a basic information relationship, a resume experience entity, and a resume experience relationship corresponding to each target person in the resume text;
constructing an individual resume visualization graph of the target person based on the basic information entity, the basic information relationship, the resume experience entity, and the resume experience relationship.

In an alternative embodiment of the present invention, the basic information entity represents basic information about the target person recognized from the resume text, for example, “Zhang San”, “28 years old” and “salesperson”, and the corresponding basic information relationship includes “name”, “age” and “position”, etc.; the resume experience entity represents departmental job resume information of the target person recognized in the text, for example, “department A”, “department B”, and “department C”, etc., and the corresponding resume experience relationships include “2000-2005”, “2006-2010”, and “2011-2015”, etc. The pre-constructed entity relationship recognition model may be a Bi-LSTM+CRF model or the like to realize an entity extraction task.

In detail, the constructing an individual resume visualization graph of the target person based on the basic information entity, the basic information relationship, the resume experience entity, and the resume experience relationship includes:
taking the target person as a root node, constructing an undirected edge between the root node and the basic information entity based on the basic information relationship, and using the basic information relationship to label the undirected edge;
constructing a directed edge between the root node and the resume experience entity based on a time sequence of the resume experience relationship, and using the resume experience relationship to label the directed edge;
aggregating all the nodes and labeled links to obtain an individual resume visualization graph.

In an alternative embodiment of the present invention, the individual resume visualization graph may be 28-age-person

$$A {\to }^{2000 ‐ 2015} department B {\to }^{2016 ‐ 2020} C ,$$

where “-age-” represents the labeled undirected edge for connecting with the basic information entity, link

$$“ {\to }^{2000 ‐ 2015} ”$$

and link

$$“ {\to }^{2016 ‐ 2020} ”$$

represent the labeled directed edge for connecting with the resume experience entity. Since the resume experience information contains a time sequence, the resume experience can be more intuitively represented through the directed edge marking.

In an embodiment of the present invention, by recognizing a basic information entity and a resume experience entity corresponding to a target person, and constructing a link and labeling between each entity based on the basic information relationship and the resume experience relationship, the resume information about the target person can be directly reflected, and the visualization degree of the resume information can be improved.

S2, performing person portrait modeling on different persons in the personal resume information set based on the individual resume visualization graph to obtain a person portrait data.

In an embodiment of the present invention, since there are a large number of entities and relationships, all representing different features of a person portrait, person portrait modeling is performed on different persons in the personal resume information set can improve the processing speed of the person feature data and facilitate the visualization of the data.

In detail, the performing person portrait modeling on different persons in the personal resume information set based on the individual resume visualization graph to obtain a person portrait data includes:
constructing a person ID of a target person in the individual resume visualization graph, outputting an entity of each node in the individual resume visualization graph as an entity tag, and outputting a relationship between each node as an entity attribute corresponding to the entity tag;
mapping the entity tag and the entity attribute with the person ID to obtain the person portrait data of the target person.

In an alternative embodiment of the present invention, for each target person, there is a unique person ID corresponding thereto; by outputting the entity of each node in the individual resume visualization graph as an entity tag, and outputting the relationship between each node as an entity attribute corresponding to the entity tag, and by mapping with the person ID, the person data in the personal resume information set can be quickly structured, thereby improving the data processing speed.

S3, performing entity clustering on different persons in the personal resume information set based on the person portrait data, constructing an entity distribution visualization graph according to the clustering result.

In an embodiment of the present invention, entity clustering refers to clustering people having the same or similar entities together and constructing an entity distribution visualization graph according to the entity distribution. the entity distribution visualization graph includes a bar graph, a pie graph, a line graph, etc.

In detail, the performing entity clustering on different persons in the personal resume information set based on the person portrait data, constructing an entity distribution visualization graph according to the clustering result includes:
determining a target attribute from the entity attribute, and performing entity division on an entity tag corresponding to the target attribute according to the target attribute and a pre-set division range;
counting persons corresponding to an entity tag in each division range, and writing a target attribute in each division range and an entity tag corresponding to the target attribute in each division range as parameters into a pre-constructed graphic visualization template to obtain a classification visualization script;
converting the classification visualization script into a visualization file in a pre-set format, and performing asynchronous loading on the visualization file to obtain a distribution visualization graph.

In an embodiment of the present invention, a pre-set visualization tool, such as ECharts, can be used for visualization processing, wherein the ECharts visualization tool is an open-source data visualization tool, and since it is a pure Javascript graph library, it can be loaded according to a js file at the time of use. the pre-constructed graphic visualization template can be a bar graph template, a pie graph template, a line graph template, etc.

In an alternative embodiment of the present invention, for example, when a target attribute is the age of different persons, entity division can be performed on entity tags corresponding to the target attribute according to pre-set division ranges to obtain each division range [20-25, 26-30, 31-35, 36-40, 41-45, 46-50, 51-55, 56-60], and the number of corresponding entity tags is [50, 51, 52, 23, 12, 8, 6, 5], which are written as parameters in a bar graph template and converted into a file in a json format, and an age entity distribution bar graph is obtained through asynchronous loading via javascript.

S4, constructing a person relationship visualization graph based on the entity relationship between different persons in the personal resume information set.

Specifically, the constructing a person relationship visualization graph based on the entity relationship between different persons in the personal resume information set includes:
recognizing a department and a post of different persons in the personal resume information set;
using a pre-constructed face recognition model to recognize person images of different persons in the personal resume information set, aggregating target persons of the same department in the personal resume information set, taking different target persons as nodes, filling the person images into corresponding nodes, and constructing an organizational relationship between different nodes based on the post, to obtain an original relationship graph;
connecting the original relationship graphs of different departments based on a pre-set organizational structure to obtain the person relationship visualization graph.

In an alternative embodiment of the present invention, the personal resume includes department entities and post entities of different persons, and an organizational relationship between target persons is constructed based on the post of a target person in the same department; at the same time, since image data exists in the resume information, a face image is captured through a face recognition model (such as FacenetFaceNet and DeepID) so as to obtain an original relationship graph, and a visualization image of a face relationship can be quickly constructed so as to improve the visual degree of the data.

In an alternative embodiment of the present invention, the using a pre-constructed face recognition model to recognize person images of different persons in the personal resume information set includes:
using a pre-constructed face recognition model to recognize face images of different persons in the personal resume information set;
performing face alignment on the recognized face image and cutting same to obtain person images of different persons in the personal resume information set.

In an alternative embodiment of the present invention, a picture containing a face image may usually contain other contents, and then necessary face detection is required; face alignment is performed by automatically estimating the coordinates of the facial feature points on the face image in the personal resume information set; the position and size of the face are accurately located; and an image with a pre-set size is cut as the person image.

In the present embodiment, an individual resume visualization graph is constructed through an entity relationship of personal resume experience in a personal resume information set; person portrait modeling is performed on different persons in the personal resume information set based on the visualization graph of an individual resume to obtain person portrait data; the personal resume data can be structured to improve data processing speed; entity clustering is performed on different persons in the personal resume information set based on the person portrait data; an entity distribution visualization graph is constructed according to the clustering result; and finally, a person relationship visualization graph is constructed based on entity relationships between different persons in the personal resume information set. It fully demonstrates the relationship between the persons and improves the visualization of the individual resume data. Therefore, the method for visualizing a personal resume proposed by the present invention can realize visualizing personal resume information.

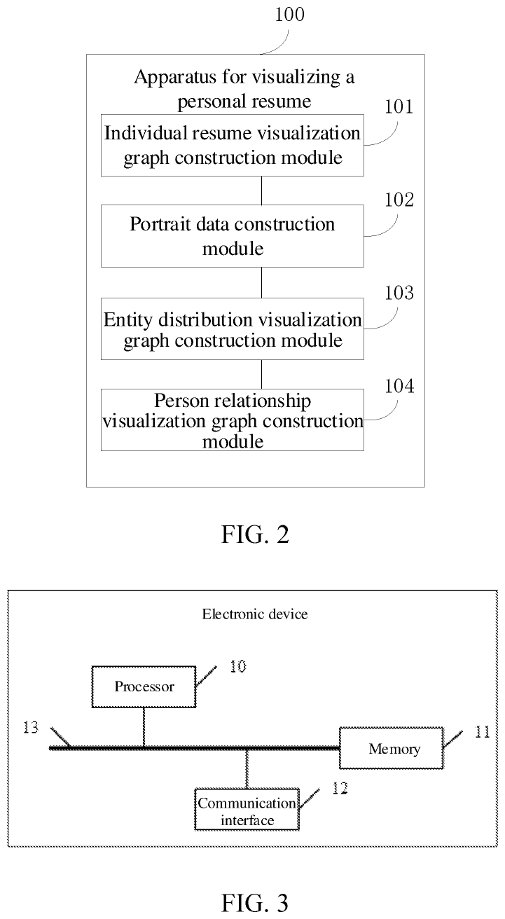

FIG. 2 is a functional module diagram of an apparatus for visualizing a personal resume according to an embodiment of the present invention.

The apparatus 100 for visualizing a personal resume of the present invention may be installed in an electronic device. According to the realized functions, apparatus 100 for visualizing a personal resume may include an individual resume visualization graph construction module 101, a portrait data construction module 102, an entity distribution visualization graph construction module 103, and a person relationship visualization graph construction module 104. A module according to the present invention, which may also be referred to as a unit, refers to a series of computer program segments capable of being executed by a processor of an electronic device and capable of performing fixed functions, which are stored in a memory of the electronic device.

In the present embodiment, the functions of each module/unit are as follows:
the individual resume visualization graph construction module 101, used for acquiring a personal resume information set, constructing an individual resume visualization graph based on an entity relationship of personal resume experience in the personal resume information set;
the portrait data construction module 102, used for performing person portrait modeling on different persons in the personal resume information set based on the individual resume visualization graph to obtain a person portrait data;
the entity distribution visualization graph construction module 103, used for performing entity clustering on different persons in the personal resume information set based on the person portrait data, constructing an entity distribution visualization graph according to the clustering result;
the person relationship visualization graph construction module 104 is used for constructing a person relationship visualization graph based on the entity relationship between different persons in the personal resume information set.

In detail, specific embodiments of various modules of the apparatus 100 for visualizing a personal resume are as follows:
step I, the individual resume visualization graph construction module 101 for acquiring a personal resume information set, constructing an individual resume visualization graph based on an entity relationship of personal resume experience in the personal resume information set.

In an embodiment of the present invention, the personal resume information set refers to past information sets of persons in enterprises and institutions in different fields, including: individual resumes, personal profiles, and individual resume experience data crawled from the Internet. The individual resume visualization graph refers to a visualization knowledge map that connects the experiences of persons in different local entities in series according to time dimension relationships, attribute dimension relationships, etc. For example, a person

$$A {⟶}^{2000 - 2015} department B ,$$

wherein person A represents a person entity, department B represents a department entity, and 2000-2015 represents a time relationship.

In detail, the constructing an individual resume visualization graph based on an entity relationship of personal resume experience in the personal resume information set includes: extracting a resume text of a target person in the personal resume information set;
using a pre-constructed entity relationship recognition model to recognize a basic information entity, a basic information relationship, a resume experience entity, and a resume experience relationship corresponding to each target person in the resume text;
constructing an individual resume visualization graph of the target person based on the basic information entity, the basic information relationship, the resume experience entity, and the resume experience relationship.

In an alternative embodiment of the present invention, the basic information entity represents basic information about the target person recognized from the resume text, for example, “Zhang San”, “28 years old” and “salesperson”, and the corresponding basic information relationship includes “name”, “age” and “position”, etc.; the resume experience entity represents departmental job resume information of the target person recognized in the text, for example, “department A”, “department B”, and “department C”, etc., and the corresponding resume experience relationships include “2000-2005”, “2006-2010”, and “2011-2015”, etc. The pre-constructed entity relationship recognition model may be a Bi-LSTM+CRF model or the like to realize an entity extraction task.

In detail, the constructing an individual resume visualization graph of the target person based on the basic information entity, the basic information relationship, the resume experience entity, and the resume experience relationship includes:
taking the target person as a root node, constructing an undirected edge between the root node and the basic information entity based on the basic information relationship, and using the basic information relationship to label the undirected edge;
constructing a directed edge between the root node and the resume experience entity based on a time sequence of the resume experience relationship, and using the resume experience relationship to label the directed edge;
aggregating all the nodes and labeled links to obtain an individual resume visualization graph.

In an alternative embodiment of the present invention, the individual resume visualization graph may be 28-age-person

$$A {\to }^{2000 ‐ 2015} department B {\to }^{2016 ‐ 2020} C ,$$

where “-age-” represents the labeled undirected edge for connecting with basic information entity, link

$$“ {\to }^{2000 ‐ 2015} ”$$

and link

$$“ {\to }^{2016 ‐ 2020} ”$$

represent the labeled directed edge for connecting with the resume experience entity. Since the resume experience information contains a time sequence, the resume experience can be more intuitively represented through the directed edge marking.

In an embodiment of the present invention, by recognizing a basic information entity and a resume experience entity corresponding to a target person, and constructing a link and labeling between each entity based on the basic information relationship and the resume experience relationship, the resume information about the target person can be directly reflected, and the visualization degree of the resume information can be improved.

Step II, the portrait data construction module 102 for performing person portrait modeling on different persons in the personal resume information set based on the individual resume visualization graph to obtain a person portrait data.

In an embodiment of the present invention, since there are a large number of entities and relationships, all representing different features of a person portrait, person portrait modeling is performed on different persons in the personal resume information set can improve the processing speed of the person feature data and facilitate the visualization of the data.

In detail, the performing person portrait modeling on different persons in the personal resume information set based on the individual resume visualization graph to obtain a person portrait data includes:
constructing a person ID of a target person in the individual resume visualization graph, outputting an entity of each node in the individual resume visualization graph as an entity tag, and outputting a relationship between each node as an entity attribute corresponding to the entity tag;
mapping the entity tag and the entity attribute with the person ID to obtain the person portrait data of the target person.

In an alternative embodiment of the present invention, for each target person, there is a unique person ID corresponding thereto; by outputting the entity of each node in the individual resume visualization graph as an entity tag, and outputting the relationship between each node as an entity attribute corresponding to the entity tag, and by mapping with the person ID, the person data in the personal resume information set can be quickly structured, thereby improving the data processing speed.

Step III, the entity distribution visualization graph construction module 103 for performing entity clustering on different persons in the personal resume information set based on the person portrait data, constructing an entity distribution visualization graph according to the clustering result.

In an embodiment of the present invention, entity clustering refers to clustering people having the same or similar entities together and constructing an entity distribution visualization graph according to the entity distribution. the entity distribution visualization graph includes a bar graph, a pie graph, a line graph, etc.

In detail, the performing entity clustering on different persons in the personal resume information set based on the person portrait data, constructing an entity distribution visualization graph according to the clustering result includes:
determining a target attribute from the entity attribute, and performing entity division on an entity tag corresponding to the target attribute according to the target attribute and a pre-set division range;
counting persons corresponding to an entity tag in each division range, and writing a target attribute in each division range and an entity tag corresponding to the target attribute in each division range as parameters into a pre-constructed graphic visualization template to obtain a classification visualization script;
converting the classification visualization script into a visualization file in a pre-set format, and performing asynchronous loading on the visualization file to obtain a distribution visualization graph.

In an embodiment of the present invention, a pre-set visualization tool, such as ECharts, can be used for visualization processing, wherein the ECharts visualization tool is an open-source data visualization tool, and since it is a pure Javascript graph library, it can be loaded according to a js file at the time of use. the pre-constructed graphic visualization template can be a bar graph template, a pie graph template, a line graph template, etc.

In an alternative embodiment of the present invention, for example, when a target attribute is the age of different persons, entity division can be performed on entity tags corresponding to the target attribute according to pre-set division ranges to obtain each division range [20-25, 26-30, 31-35, 36-40, 41-45, 46-50, 51-55, 56-60], and the number of corresponding entity tags is [50, 51, 52, 23, 12, 8, 6, 5], which are written as parameters in a bar graph template and converted into a file in a json format, and an age entity distribution bar graph is obtained through asynchronous loading via javascript.

Step IV, the person relationship visualization graph construction module 104 for constructing a person relationship visualization graph based on the entity relationship between different persons in the personal resume information set.

Specifically, the constructing a person relationship visualization graph based on the entity relationship between different persons in the personal resume information set includes:
recognizing a department and a post of different persons in the personal resume information set;
using a pre-constructed face recognition model to recognize person images of different persons in the personal resume information set, aggregating target persons of the same department in the personal resume information set, taking different target persons as nodes, filling the person images into corresponding nodes, and constructing an organizational relationship between different nodes based on the post, to obtain an original relationship graph;
connecting the original relationship graphs of different departments based on a pre-set organizational structure to obtain the person relationship visualization graph.

In an alternative embodiment of the present invention, the personal resume includes department entities and post entities of different persons, and an organizational relationship between target persons is constructed based on the post of a target person in the same department; at the same time, since image data exists in the resume information, a face image is captured through a face recognition model (such as FacenetFaceNet and DeepID) so as to obtain an original relationship graph, and a visualization image of a face relationship can be quickly constructed so as to improve the visual degree of the data.

In an alternative embodiment of the present invention, the using a pre-constructed face recognition model to recognize person images of different persons in the personal resume information set includes:
using a pre-constructed face recognition model to recognize face images of different persons in the personal resume information set;
performing face alignment on the recognized face image and cutting same to obtain person images of different persons in the personal resume information set.

In an alternative embodiment of the present invention, a picture containing a face image may usually contain other contents, and then necessary face detection is required; face alignment is performed by automatically estimating the coordinates of the facial feature points on the face image in the personal resume information set; the position and size of the face are accurately located; and an image with a pre-set size is cut as the person image.

In the present embodiment, an individual resume visualization graph is constructed through an entity relationship of personal resume experience in a personal resume information set; person portrait modeling is performed on different persons in the personal resume information set based on the visualization graph of an individual resume to obtain person portrait data; the personal resume data can be structured to improve data processing speed; entity clustering is performed on different persons in the personal resume information set based on the person portrait data; an entity distribution visualization graph is constructed according to the clustering result; and finally, a person relationship visualization graph is constructed based on entity relationships between different persons in the personal resume information set. It fully demonstrates the relationship between the persons and improves the visualization of the individual resume data. Therefore, the apparatus for visualizing a personal resume according to the present invention can realize the visualization of personal resume information.

FIG. 3 is a structure diagram of an electronic device for realizing the method for visualizing a personal resume according to an embodiment of the present invention.

The electronic device may include a processor 10, a memory 11, a communication interface 12, and a bus 13, and may further include a computer program stored in the memory 11 and run on the processor 10, such as a program for visualizing a personal resume.

Wherein, the memory 11 includes at least one type of readable storage medium, and the readable storage medium includes a flash memory, a mobile hard disk, a multimedia card, and a card-type memory (for example: SD or DX memory, etc.), magnetic memory, magnetic disk, optical disk, etc. The memory 11 may in some embodiments be an internal storage unit of the electronic device, such as a mobile hard disk of the electronic device. The memory 11 may also be an external storage device of the electronic device in other embodiments, such as a plug-in mobile hard disk, a smart media card (SMC), a secure digital (SD) card, a flash card, etc. provided on the electronic device. Further, the memory 11 may include both an internal storage unit and an external storage device of the electronic device. The memory 11 may be used not only to store application software installed in an electronic device and various types of data, such as codes of a program for visualizing a personal resume but also to temporarily store data that has been output or is to be output.

The processor 10 may, in some embodiments, be included of an integrated circuit, such as a single packaged integrated circuit, or a plurality of integrated circuits packaged with the same or different functions, including one or more central processing units (CPU), microprocessors, digital processing chips, graphics processors, combinations of various control chips, etc. The processor 10 is a control unit of the electronic device, connects various components of the entire electronic device using various interfaces and lines, performs various functions of the electronic device, and processes data by running or executing programs or modules stored in the memory 11 (e.g. a program for visualizing a personal resume, etc.), and calling data stored in the memory 11.

The communication interface 12 is used for communication between the electronic device and other devices, including network interfaces and user interfaces. Optionally, the network interface may include a wired interface and/or a wireless interface (e.g. a WI-FI interface, a Bluetooth interface, etc.), typically for establishing a communication connection between the electronic device and other electronic devices. The user interface may be a display, an input unit (such as a keyboard), optionally, a standard wired interface, or a wireless interface. Optionally, in some embodiments, the display may be an LED display, a liquid crystal display, a touch-sensitive liquid crystal display, an OLED (Organic Light-Emitting Diode) touchpad, or the like. Where appropriate, the display may also be referred to as a display screen or display unit for displaying information processed in the electronic device and for displaying a visualized user interface.

The communication bus 13 may be a peripheral component interconnect (PCI) bus, an extended industry standard architecture (EISA) bus, or the like. The bus 13 may be divided into an address bus, a data bus, a control bus, etc. The bus 13 is arranged to realize the connection communication between the memory 11 and at least one processor 10 etc.

While only electronic devices having components are shown in FIG. 3, those skilled in the art will appreciate that the structures shown in FIG. 3 are not to be construed as limiting the electronic devices and may include fewer or more components than those shown, or some components in combination, or different arrangements of components.

For example, although not shown, the electronic device may also include a power source (e.g. a battery) to power the various components. Preferably, the power source may be logically connected to at least one processor 10 through the power management apparatus to realize charging management, discharging management, and power consumption management functions through the power management apparatus. The power supply may also include one or more of a DC or AC power source, a recharging device, a power failure detection circuit, a power converter or inverter, a power status indicator, and any other component. The electronic device may also include various sensors, Bluetooth modules, Wi-Fi modules, etc. which will not be described in detail herein.

Further, the electronic device may also include a network interface, optionally, the network interface may include a wired interface and/or a wireless interface (e.g. a WI-FI interface, a Bluetooth interface, etc.), typically for establishing a communication connection between the electronic device and other electronic devices.

Optionally, the electronic device may further include a user interface, which may be a display, an input unit (such as a keyboard), optionally, a standard wired interface, or a wireless interface. Optionally, in some embodiments, the display may be an LED display, a liquid crystal display, a touch-sensitive liquid crystal display, an OLED (Organic Light-Emitting Diode) touchpad, or the like. Where appropriate, the display may also be referred to as a display screen or display unit for displaying information processed in the electronic device and for displaying a visualized user interface.

It should be understood that the examples are for illustrative purposes only and are not to be construed as limiting the scope of the patent application.

The program for visualizing a personal resume stored in the memory 11 in the electronic device is a combination of a plurality of instructions, and when running in the processor 10, can realize:
acquiring a personal resume information set, constructing an individual resume visualization graph based on an entity relationship of personal resume experience in the personal resume information set;
performing person portrait modeling on different persons in the personal resume information set based on the individual resume visualization graph to obtain a person portrait data;
performing entity clustering on different persons in the personal resume information set based on the person portrait data, constructing an entity distribution visualization graph according to the clustering result;
constructing a person relationship visualization graph based on the entity relationship between different persons in the personal resume information set.

Specifically, the specific implementation of the above instructions by the processor 10 may refer to the description of the relevant steps in the corresponding embodiments of the figures, which will not be repeated here.

Further, the integrated modules/units of the electronic device, if realized in the form of software functional units and sold or used as stand-alone products, may be stored in a computer-readable storage medium. The computer-readable storage medium can be volatile or non-volatile. For example, the computer-readable medium may include any entity or apparatus, recording medium, U disk, removable hard disk, magnetic disk, optical disk, computer memory, or read-only memory (ROM), capable of carrying the computer program code.

The present invention also provides a computer-readable storage medium storing a computer program which, when executed by a processor of an electronic device, realizes:
acquiring a personal resume information set, constructing an individual resume visualization graph based on an entity relationship of personal resume experience in the personal resume information set;
performing person portrait modeling on different persons in the personal resume information set based on the individual resume visualization graph to obtain a person portrait data;
performing entity clustering on different persons in the personal resume information set based on the person portrait data, constructing an entity distribution visualization graph according to the clustering result;
constructing a person relationship visualization graph based on the entity relationship between different persons in the personal resume information set.

In several embodiments provided by the present invention, it should be understood that the disclosed apparatus, device, and method may be realized in other ways. For example, the apparatus embodiments described above are merely illustrative, e.g. the division of modules is only a logical function division, and there may be other division methods in actual realization.

the modules illustrated as separate components may or may not be physically separated, the components shown as modules may or may not be physical units, i.e. may be located in one place, or may also be distributed over a plurality of network elements. Some or all of the modules may be selected to realize the objectives of the embodiments according to actual needs.

In addition, various functional modules in various embodiments of the present invention may be integrated in one processing unit, may be physically present in separate units, or may be integrated in one unit in two or more units. The above-mentioned integrated units can be realized in the form of hardware or the form of hardware plus software functional modules.

It will be evident to those skilled in the art that the invention is not limited to the details of the foregoing illustrative embodiments, and that the present invention may be realized in other specific forms without departing from the spirit or essential characteristics thereof.

The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein. Any reference signs in the claims shall not be construed as limiting the claim concerned.

Embodiments of the present application may acquire and process relevant data based on artificial intelligence techniques. Among them, artificial intelligence (AI) is a theory, method, technology, and application system that uses a digital computer or digital computer-controlled machine to simulate, extend, and expand human intelligence, perceive the environment, acquire knowledge, and use the knowledge to obtain the best results.

The basic technologies of artificial intelligence generally include such technologies as sensors, special artificial intelligence chips, cloud computing, distributed storage, large data processing technology, operation/interaction systems, electromechanical integration, etc. Artificial intelligence software technology mainly includes computer vision technology, robot technology, biological recognition technology, speech processing technology, natural language processing technology, and machine learning/in-depth learning.

Furthermore, it will be understood that the word “comprise” or “include” does not exclude other units or steps and the singular does not exclude the plural. A plurality of the units or apparatus recited in the system claims may also be realized by one unit or apparatus by software or hardware. The terms second, etc. are used to refer to names and do not denote any particular order.

Finally, it is to be understood that the above-described embodiments are merely illustrative of the invention and not restrictive, although the invention has been described in detail with reference to preferred embodiments. It will be understood by those of ordinary skill in the art that changes may be made or equivalents may be substituted for elements thereof without departing from the spirit and scope of the invention.

What is claimed is:

1. A method for visualizing a personal resume, the method comprising:
acquiring a personal resume information set, constructing an individual resume visualization graph based on an entity relationship of personal resume experience in the personal resume information set;
performing person portrait modeling on different persons in the personal resume information set based on the individual resume visualization graph to obtain a person portrait data;
performing entity clustering on different persons in the personal resume information set based on the person portrait data, constructing an entity distribution visualization graph according to the clustering result;
constructing a person relationship visualization graph based on an entity relationship between different persons in the personal resume information set.

2. The method for visualizing a personal resume of claim 1, wherein the constructing an individual resume visualization graph based on an entity relationship of personal resume experience in the personal resume information set comprises:
extracting a resume text of a target person in the personal resume information set;
using a pre-constructed entity relationship recognition model to recognize a basic information entity, a basic information relationship, a resume experience entity, and a resume experience relationship corresponding to each target person in the resume text;
constructing an individual resume visualization graph of the target person based on the basic information entity, the basic information relationship, the resume experience entity, and the resume experience relationship.

3. The method for visualizing a personal resume of claim 2, wherein the constructing an individual resume visualization graph of the target person based on the basic information entity, the basic information relationship, the resume experience entity, and the resume experience relationship comprises:
taking the target person as a root node, constructing an undirected edge between the root node and the basic information entity based on the basic information relationship, and using the basic information relationship to label the undirected edge;
constructing a directed edge between the root node and the resume experience entity based on a time sequence of the resume experience relationship, and using the resume experience relationship to label the directed edge;
aggregating all the nodes and labeled links to obtain an individual resume visualization graph.

4. The method for visualizing a personal resume of claim 1, wherein the performing person portrait modeling on different persons in the personal resume information set based on the individual resume visualization graph to obtain a person portrait data comprises:
constructing a person ID of a target person in the individual resume visualization graph, outputting an entity of each node in the individual resume visualization graph as an entity tag, and outputting a relationship between each node as an entity attribute corresponding to the entity tag;
mapping the entity tag and the entity attribute with the person ID to obtain the person portrait data of the target person.

5. The method for visualizing a personal resume of claim 4, wherein the performing entity clustering on different persons in the personal resume information set based on the person portrait data, constructing an entity distribution visualization graph according to the clustering result comprises:
determining a target attribute from the entity attribute, and performing entity division on an entity tag corresponding to the target attribute according to the target attribute and a pre-set division range;
counting persons corresponding to an entity tag in each division range, and writing a target attribute in each division range and an entity tag corresponding to the target attribute in the each division range as parameters into a pre-constructed graphic visualization template to obtain a classification visualization script;
converting the classification visualization script into a visualization file in a pre-set format, and performing asynchronous loading on the visualization file to obtain a distribution visualization graph.

6. The method for visualizing a personal resume of claim 1, wherein the constructing a person relationship visualization graph based on the entity relationship between different persons in the personal resume information set comprises:
recognizing a department and a post of different persons in the personal resume information set;
using a pre-constructed face recognition model to recognize person images of different persons in the personal resume information set, aggregating target persons of the same department in the personal resume information set, taking different target persons as nodes, filling the person images into corresponding nodes, and constructing an organizational relationship between different nodes based on the post, to obtain an original relationship graph;
connecting the original relationship graphs of different departments based on a pre-set organizational structure to obtain the person relationship visualization graph.

7. The method for visualizing a personal resume of claim 6, wherein the using a pre-constructed face recognition model to recognize person images of different persons in the personal resume information set comprises:
using a pre-constructed face recognition model to recognize face images of different persons in the personal resume information set;
performing face alignment on the recognized face image and cutting same to obtain person images of different persons in the personal resume information set.

8. An electronic device, the electronic device comprising:
at least one processor; and,
a memory communicatively connected to the at least one processor; wherein,
the memory stores a computer program executable by the at least one processor, the computer program is executed by the at least one processor to enable the at least one processor to execute the steps of:
acquiring a personal resume information set, constructing an individual resume visualization graph based on an entity relationship of personal resume experience in the personal resume information set;
performing person portrait modeling on different persons in the personal resume information set based on the individual resume visualization graph to obtain a person portrait data;
performing entity clustering on different persons in the personal resume information set based on the person portrait data, constructing an entity distribution visualization graph according to the clustering result;
constructing a person relationship visualization graph based on the entity relationship between different persons in the personal resume information set.

9. The electronic device of claim 8, wherein the constructing an individual resume visualization graph based on an entity relationship of personal resume experience in the personal resume information set comprises:
extracting a resume text of a target person in the personal resume information set;
using a pre-constructed entity relationship recognition model to recognize a basic information entity, a basic information relationship, a resume experience entity, and a resume experience relationship corresponding to each target person in the resume text;
constructing an individual resume visualization graph of the target person based on the basic information entity, the basic information relationship, the resume experience entity, and the resume experience relationship.

10. The electronic device of claim 9, wherein the constructing an individual resume visualization graph of the target person based on the basic information entity, the basic information relationship, the resume experience entity, and the resume experience relationship comprises:
taking the target person as a root node, constructing an undirected edge between the root node and the basic information entity based on the basic information relationship, and using the basic information relationship to label the undirected edge;
constructing a directed edge between the root node and the resume experience entity based on a time sequence of the resume experience relationship, and using the resume experience relationship to label the directed edge;
aggregating all the nodes and labeled links to obtain an individual resume visualization graph.

11. The electronic device of claim 8, wherein the performing person portrait modeling on different persons in the personal resume information set based on the individual resume visualization graph to obtain a person portrait data comprises:
constructing a person ID of a target person in the individual resume visualization graph, outputting an entity of each node in the individual resume visualization graph as an entity tag, and outputting a relationship between each node as an entity attribute corresponding to the entity tag;
mapping the entity tag and the entity attribute with the person ID to obtain the person portrait data of the target person.

12. The electronic device of claim 11, wherein the performing entity clustering on different persons in the personal resume information set based on the person portrait data, constructing an entity distribution visualization graph according to the clustering result comprises:
determining a target attribute from the entity attribute, and performing entity division on an entity tag corresponding to the target attribute according to the target attribute and a pre-set division range;
counting persons corresponding to an entity tag in each division range, and writing a target attribute in each division range and an entity tag corresponding to the target attribute in the each division range as parameters into a pre-constructed graphic visualization template to obtain a classification visualization script;
converting the classification visualization script into a visualization file in a pre-set format, and performing asynchronous loading on the visualization file to obtain a distribution visualization graph.

13. The electronic device of claim 8, wherein the constructing a person relationship visualization graph based on the entity relationship between different persons in the personal resume information set comprises:
recognizing a department and a post of different persons in the personal resume information set;
using a pre-constructed face recognition model to recognize person images of different persons in the personal resume information set, aggregating target persons of the same department in the personal resume information set, taking different target persons as nodes, filling the person images into corresponding nodes, and constructing an organizational relationship between different nodes based on the post, to obtain an original relationship graph;
connecting the original relationship graphs of different departments based on a pre-set organizational structure to obtain the person relationship visualization graph.

14. The electronic device of claim 13, wherein the using a pre-constructed face recognition model to recognize person images of different persons in the personal resume information set comprises:
using a pre-constructed face recognition model to recognize face images of different persons in the personal resume information set;
performing face alignment on the recognized face image and cutting same to obtain person images of different persons in the personal resume information set.

15. A non-volatile computer-readable storage medium storing a computer program, the computer program when executed by a processor realizing the following steps:
acquiring a personal resume information set, constructing an individual resume visualization graph based on an entity relationship of personal resume experience in the personal resume information set;
performing person portrait modeling on different persons in the personal resume information set based on the individual resume visualization graph to obtain a person portrait data;
performing entity clustering on different persons in the personal resume information set based on the person portrait data, constructing an entity distribution visualization graph according to the clustering result;
constructing a person relationship visualization graph based on the entity relationship between different persons in the personal resume information set.

16. The non-volatile computer-readable storage medium of claim 15, wherein the constructing an individual resume visualization graph based on an entity relationship of personal resume experience in the personal resume information set comprises:
extracting a resume text of a target person in the personal resume information set;
using a pre-constructed entity relationship recognition model to recognize a basic information entity, a basic information relationship, a resume experience entity, and a resume experience relationship corresponding to each target person in the resume text;
constructing an individual resume visualization graph of the target person based on the basic information entity, the basic information relationship, the resume experience entity, and the resume experience relationship.

17. The non-volatile computer-readable storage medium of claim 16, wherein the constructing an individual resume visualization graph of the target person based on the basic information entity, the basic information relationship, the resume experience entity, and the resume experience relationship comprises:
taking the target person as a root node, constructing an undirected edge between the root node and the basic information entity based on the basic information relationship, and using the basic information relationship to label the undirected edge;
constructing a directed edge between the root node and the resume experience entity based on a time sequence of the resume experience relationship, and using the resume experience relationship to label the directed edge;
aggregating all the nodes and labeled links to obtain an individual resume visualization graph.

18. The non-volatile computer-readable storage medium of claim 15, wherein the performing person portrait modeling on different persons in the personal resume information set based on the individual resume visualization graph to obtain a person portrait data comprises:
constructing a person ID of a target person in the individual resume visualization graph, outputting an entity of each node in the individual resume visualization graph as an entity tag, and outputting a relationship between each node as an entity attribute corresponding to the entity tag;
mapping the entity tag and the entity attribute with the person ID to obtain the person portrait data of the target person.

19. The non-volatile computer-readable storage medium of claim 18, wherein the performing entity clustering on different persons in the personal resume information set based on the person portrait data, constructing an entity distribution visualization graph according to the clustering result comprises:
determining a target attribute from the entity attribute, and performing entity division on an entity tag corresponding to the target attribute according to the target attribute and a pre-set division range;
counting persons corresponding to an entity tag in each division range, and writing a target attribute in each division range and an entity tag corresponding to the target attribute in the each division range as parameters into a pre-constructed graphic visualization template to obtain a classification visualization script;
converting the classification visualization script into a visualization file in a pre-set format, and performing asynchronous loading on the visualization file to obtain a distribution visualization graph.

20. The non-volatile computer-readable storage medium of claim 15, wherein the constructing a person relationship visualization graph based on the entity relationship between different persons in the personal resume information set comprises:
recognizing a department and a post of different persons in the personal resume information set;
using a pre-constructed face recognition model to recognize person images of different persons in the personal resume information set, aggregating target persons of the same department in the personal resume information set, taking different target persons as nodes, filling the person images into corresponding nodes, and constructing an organizational relationship between different nodes based on the post, to obtain an original relationship graph;
connecting the original relationship graphs of different departments based on a pre-set organizational structure to obtain the person relationship visualization graph.
